(19) United States
(12) Patent Application Publication
(10) Pub. No.: US 2017/0293402 A1
(43) Pub. Date: Oct. 12, 2017

(54) VARIABLE DWELL TIME KEYBOARD

(71) Applicant: Microsoft Technology Licensing, LLC, Redmond, WA (US)

(72) Inventors: Meredith June Morris, Bellevue, WA (US); Shane Frandon Williams, Seattle, WA (US); Mira Eileen Shah, Seattle, WA (US); Ann Paradiso, Shoreline, WA (US); Harish S. Kulkarni, Redmond, WA (US); Martez Mott, Seattle, WA (US); Jay Curtis Beavers, Duvall, WA (US); Jonathan Thomas Campbell, Redmond, WA (US); Peter John Ansell, Bellevue, WA (US)

(21) Appl. No.: 15/097,144

(22) Filed: Apr. 12, 2016

(51) Int. Cl. G06F 3/0482; G06F 17/28; G06F 3/0484; G06F 17/27; G06F 3/0488; G06F 3/01

(52) U.S. Cl. CPC G06F 3/0482; G06F 3/04886; G06F 3/013; G06F 3/04842; G06F 17/276; G06F 17/28

(57) ABSTRACT

The systems and techniques described herein implement an improved gaze-based on-screen keyboard that provide dynamically variable dwell times to increase throughput and reduce errors. Utilizing a language model, the probability that each key of the on-screen keyboard will be the subsequential key can be determined, and based at least in part on this determined probability, a dwell time can be assigned to each key. When used as an iterative process, a minimum dwell time may be gradually reduced as confidence in the subsequential key increases to provide a cascading minimum dwell time.

### BACKGROUND

Gaze-based keyboards in which the gaze of a user is tracked with eye tracking technology and a key on the keyboard is selected as the user dwells his or her gaze on an on-screen keyboard are particularly important for people with severe mobility restrictions such as paralysis and neurodegenerative conditions. However, one of the drawbacks of such keyboards is the notoriously slow throughput, requiring a user to select individual keys by dwelling their gaze upon each key a relatively long dwell time. The result is a frustratingly slow ability to enter strings of characters.

### SUMMARY

The systems, methods, and techniques described herein provide for a computing device having a display, a storage subsystem, and a logic subsystem, the storage subsystem storing instructions that, when executed by the logic subsystem, cause the computing device to present an on-screen keyboard for eye-typing. The keyboard has at least a first key and a second key, and in some instances has twenty-six alpha keys, along with non-alpha keys, such as a space key, a backspace key, an enter key, a number key, and other keys that may typically be found on a keyboard.

According to some embodiments, a baseline dwell time is assigned to the first key. The baseline dwell time determines how long a user must gaze at the first key in order to select the first key. The baseline dwell time may be configured by the user based upon the skill and experience of the user in operating gaze-based keyboards. It may also be configured by the system based upon the keyboard, the size of the display, and the environment in which the keyboard is used.

A gaze-tracking sensor may be used to sense the direction of gaze of a user of the keyboard and a selection of a key can be detected. The selection of a key may be indicated by a user fixing his or her gaze upon a desired key for a period of time meeting or exceeding the dwell time. A language model may be implemented, such as a predictive word-based language model, to determine a probability of the subsequent key that is likely to be selected. The probability may be determined for each key on the keyboard based upon the previous keys entered.

Based upon the probability, a dwell time may be assigned to each key on the keyboard. In some instances, the dwell time is shorter than the baseline dwell time, while in other instances, the dwell time may be longer than the baseline dwell time. This is due, in part, to the fact that based upon previous inputs, some keys will have a higher probability of being selected as the next key, while other keys will have a lower probability of being selected as the next key, and the dwell time may be assigned accordingly.

As additional keys are selected and begin to form a string of text, the system, using the predictive language model, may continue determining the probability of each subsequent key and assigning corresponding dwell times to each key. As this process is iterated, the predictive language model may increase its confidence in predicting the subsequent key, or even subsequent words, and assign dwell times to keys accordingly.

Where the probability of a subsequent key is relatively high (e.g., above a pre-defined high probability threshold), the dwell time for the subsequent key may be shorter than the dwell time for the previous key. The system may determine a maximum dwell time, which may be programmed into the system, or may be set by a user of the system. Where the probability of a key being the next key is low (e.g., below a pre-defined low probability threshold), such as below about 1%, the key may be assigned the maximum dwell time. While it is still possible to enter a key having a very low probability, it requires gazing at the key for the maximum dwell time. In some embodiments, the maximum dwell time may be about 1000 ms.

Where the predictive language model indicates that a string of entered text matches a word within a dictionary used by the predictive language model, the system may determine that the space key is a highly probable next key and the space key may be assigned the minimum dwell time. In some instances, the minimum dwell time may be 100 ms, or 200 ms, or some other increment of time specified by the system or the user.

Also described herein is a method of eye-typing. Initially, a baseline dwell time is established for the keys displayed in an on-screen keyboard. A first input is received selecting a key corresponding to a first character. Based upon the first character, a language model may help to determine the probability of each key/character on the keyboard being selected as the next key. The probability may be determined for each key on the keyboard, and may be determined after each sequential key is entered. Based upon the probability of each key being the next key, a dwell time is assigned to each key. That is, in various examples, keys having a higher probability of being the next key will be assigned a dwell time shorter than the baseline dwell time while keys having a lower probability of being the next key will be assigned a dwell time that is longer than the baseline dwell time.

This process may be iterated after each successive key is entered. As additional keys are entered, the language model may be able to predict the subsequent key with a high degree of confidence. However, even though the system may be able to predict the next key with a high degree of confidence, rather than dramatically reduce the dwell time for the keys having a high probability of being the next key, the dwell time may gradually reduce, i.e., a cascading minimum dwell time, such that the typing rhythm will gradually increase rather than experience a drastic step change in typing cadence.

The language model may determine subsequent key probabilities by generating an N-best list of words based upon the previous input. The N-best list of words may be analyzed to determine the occurrences of characters that appear immediately after the previous input. The number of the occurrences divided by a number of words in the N-best list of words results in a probability of each key being the next key to be entered.

Where the previous input results in a string of text that corresponds with a word contained in a word prediction engine, the space key may be assigned a relatively short dwell time, such as the cascading minimum dwell time. Similarly, where the previous input results in a string of text that does not correspond with a word contained in a word prediction engine, the system may determine that a spelling error has likely occurred and the backspace key may be assigned a relatively short dwell time, thereby making it efficient for a user to indicate the backspace key as a desired key to correct typing errors.

In addition to relying on the word prediction engine to determine probabilities of subsequent keys, the probabilities may also be determined, at least in part, upon a number of adjacent keys which are likely to be selected.

Some embodiments result in a system for eye-typing, the system having one or more processors and memory in communication with the processors, and a display such as a monitor or screen. The system may further have instructions stored on the memory that, when executed by the one or more processors, cause the system to present a gaze-based keyboard on the display. The keyboard may have one or more keys that are selectable by gazing at the individual keys for a dwell time.

The system may be configured to determine a probability for each of the keys on the keyboard as being selected as the next character input. Based at least in part on the probability, a dwell time may be assigned to each of the keys. The dwell time may be selectable between a minimum dwell time and a maximum dwell time. For example, the dwell time may be set to the maximum dwell time for keys in which the probability of the keys being selected next is less than 1%.

The dwell time may be gradually reduced between sequential keys based upon a number of keys previously selected. That is, as the system increases in confidence as to which keys are likely to be selected next, the dwell time for those highly likely keys gradually reduces as additional keys are entered and the language model narrows down the possible list of words that is being entered by the user. As the possible list of words narrows, the word prediction engine achieves a high degree of confidence as to which word the user is in the process of entering.

The keys displayed on the on-screen keyboard each have a boundary, or a target, that defines an area within which the key is selectable. The boundary may be variably sized, and may be based at least in part, upon the probability that the key will be selected next. That is, keys with a high probability of being selected next may have a larger target than those keys having a low probability of being selected. For example, the boundary of a key may be increased in size based upon the probability that the key will be selected next is greater than 25%. Of course, other threshold probability numbers may be used to determine when to modify the size of the key boundary, such as greater than about 10%, 15%, or some other desirable probability.

The result of the ensuing description is an improved eye-typing system in which dwell times for subsequent keys are dynamically determined based upon the probability that each key will be selected as a next character input. In other words, each key may have a unique dwell time assigned to it based upon the unique probability that the key will be the next key selected. The probability is determined based upon the previously entered keys in combination with a predictive language model, and may also be based upon the number of adjacent keys that are also likely to be selected.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical elements.

FIG. 1 is an illustration of one embodiment of a system for eye-typing and determining dwell times.

FIG. 2 is a schematic layout of a virtual keyboard for eye-gazing input showing an eye gaze input path.

FIG. 3 is a flow diagram of an example process for determining variable dwell times based upon input probabilities.

FIG. 4 is a flow diagram of another example process for determining variable dwell times based upon a probabilistic language model.

FIG. 5 is a schematic layout of a virtual keyboard for eye-gazing input showing an enhanced input target.

### DETAILED DESCRIPTION

The techniques and systems described herein can be used to provide an improved user experience when eye typing using a gaze-based virtual keyboard. Specifically, the techniques and systems described herein provide for a variable dwell time keyboard that uses probabilistic language models, spatial adjacency of keys, and typing cadence preservation to vary the dwell-time for each subsequential keyed input.

Standard eye-typing techniques involve a user fixating his or her gaze on each key for a relatively long period of time in order to enter the key as an input character. The system detects and processes the user's gaze to determine an intended word on a key-by-key basis. The required time that a user must gaze at a desired key in order to select that key for input is referred to as a dwell time. In many standard eye-typing keyboards, the dwell time is static, and may be on the order of 600 milliseconds, or even longer, which can result in a frustratingly slow method of typing.

Some embodiments described herein address this frustration by computing and assigning a dwell time for each subsequential key by (1) using a probabilistic language model to predict the probability of each input key being selected as the subsequential input and/or (2) factoring in the spatial adjacency of keys to determine dwell times, or a combination. Each key in the on-screen keyboard is associated with a number, a symbol, a command, a character, punctuation, or other such function or input, and thus, when referring to selection of a key, the description is also referring to selection of a character, number, symbol, command, or punctuation and the key and character combination can be selected by an eye gaze.

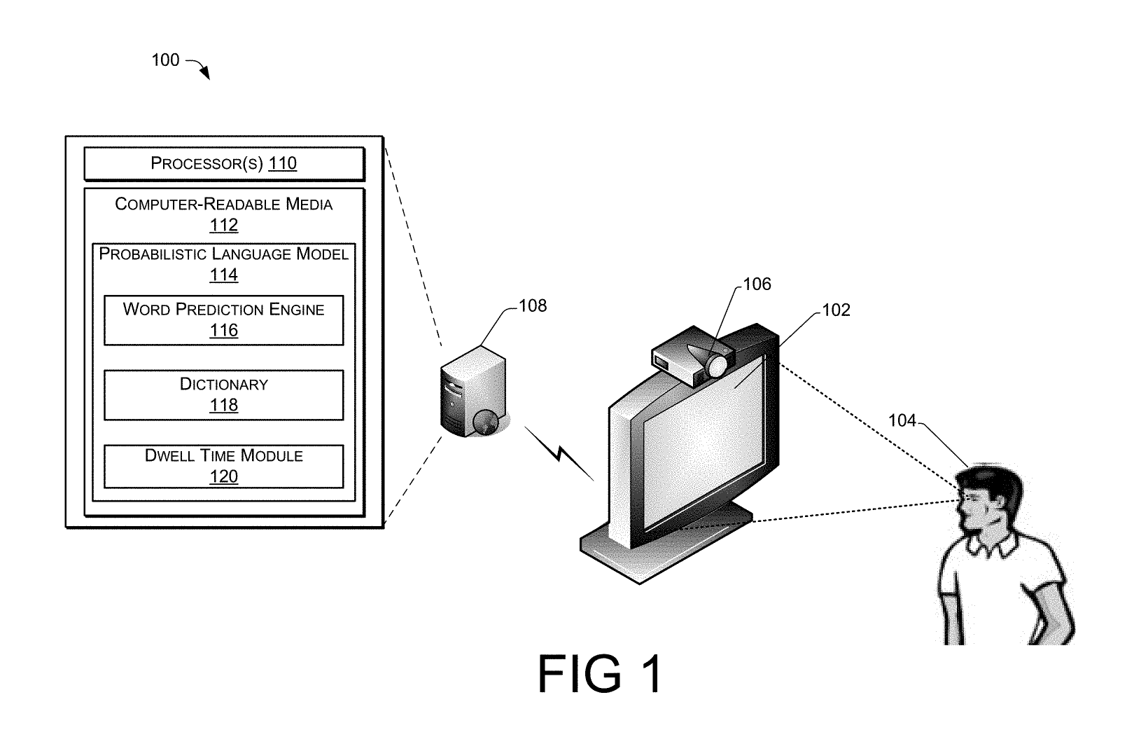

With reference to FIG. 1, an example embodiment of a system 100 for eye-typing is illustrated. The system 100 generally includes a display 102 that may present an on-screen keyboard to facilitate eye-typing by a user 104. A gaze-tracking sensor 106 may be provided to detect the direction of gaze of the user 104, and in particular, to detect the gaze of a user 104 as the user 104 fixates on a key displayed as part of the on-screen keyboard on the display 102.

A computing device 108 is in communication with the display 102 and the gaze-tracking sensor 106. The computing device 108 may be local to the display 102 and/or connected directly to the display 102, such as by using one or more appropriate cables to facilitate data communication between the display 102, the gaze-tracking sensor 106 and the computing device 108. In some instances, the computing device 108 may be located remotely from the display 102 and may communicate wirelessly, such as over the internet. In other instances, the computing device 108 may have some portion located locally with the display 102 and the gaze-tracking sensor 106, while other parts are located remotely. According to some embodiments, the computing device 108 may be a desktop computer, a laptop computer, a smartphone, a tablet computer, a head-mounted computer, or some other computing device that is capable of being operated as described herein.

In some instances, the computing device 108 is primarily responsible for sending data to the display 102 with instructions that the display 102 present the data, which in some cases, is an on-screen keyboard. The computing device 108 may also be in communication with the gaze-tracking sensor 106 and receive data from the gaze-tracking sensor that indicates the locations of the gaze of a user 104. In some cases, the gaze-tracking sensor 106 may communicate directly with the display 102 and may determine not only the direction of the gaze of a user 104, but also determine a specific key on the on-screen keyboard that the user 104 is gazing at. In other embodiments, the computing device 108 receives gaze location data from the gaze-tracking sensor and determines the key that the user 104 is gazing at.

According to other embodiments, the display 102, the gaze-tracking sensor 106, and the computing device 108 may all be components of a single device, such as, for example, where the display is a head-mounted display. The display 102 may be any suitable display device, such as, for example, a computer monitor, a television display, a head-mounted see-through display, a mobile computing device, a tablet display, a smartphone display, or any other such suitable display device

The computing device 108 includes one or more processors 110 and computer-readable media 112 communicatively coupled to the one or more processors 110. The computer-readable media 112 stores one or more modules such as a probabilistic language model 114. The probabilistic language model 114 may include a word prediction engine 116, a dictionary 118, and a dwell time module 120. Of course, some of the modules or components, such as the dictionary 118 or the dwell time module 120 may be stored elsewhere, such as in a remote database, as part of the display, or at some other location. In some instances, the dictionary 118 used by the system 100 may comprise a local dictionary stored in the computer-readable media 112 or a remote dictionary available from another resource, or a combination.

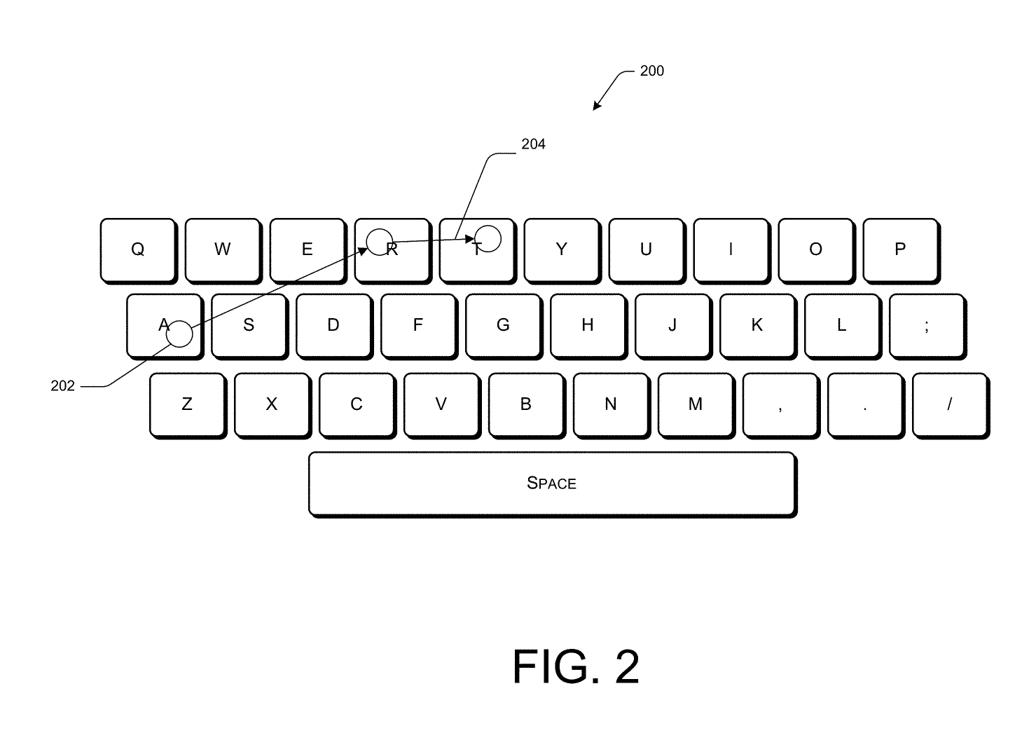

With reference to FIG. 2, an example embodiment of an on-screen keyboard 200 for use in gaze-based typing is shown. The on-screen keyboard may be displayed on a suitable display device, such as, for example, a computer monitor, a television display, a head-mounted see-through display, a mobile computing device, a tablet display, a smartphone display, or other such suitable display device.

The on-screen keyboard 200 includes a plurality of keys and may be laid out, for example, in a QWERTY layout, or may be arranged in some other desirable configuration or format. The on-screen keyboard 200 may also be used in conjunction with any suitable eye gaze tracking hardware or software. For example, one or more gaze-tracking sensors 106 may be present to facilitate eye-typing by tracking the gaze of a user 104. The gaze-tracking sensor(s) 106 may be located on the display device 102, adjacent to the display device 102, embedded within the display device 102, worn by a user 104, or a combination. In some embodiments, the display device 102 may be a head-mounted see-through display and the gaze-tracking sensor 106 may be attached to, or embedded within, the see-through display 106. The gaze-tracking sensor 106 may collect information and generate data related to the location of the gaze of a user 104 interacting with the on-screen keyboard 200.

FIG. 2 illustrates an example of an eye-typing sequence on a letter-by-letter basis. The user 104 may briefly focus his or her gaze on a letter for selection. The circles 202 shown on the on-screen keyboard 200 indicate a selected letter (e.g., “A”, “R”, and “T”), while the eye tracking movement from letter to letter is represented by arrows 204. In order to select a letter, current eye-typing techniques typically require a user 104 to gaze at a desired letter for a predetermined period of time, or a dwell time. In many cases, this dwell time may be on the order of 600 milliseconds (ms) or may be as high as 1000 ms or more. The result is a frustratingly slow method of text entry. While in some cases the dwell time may be adjustable based upon the skill and experience of the typist, the dwell time remains a static time period, for all the keys, during which a user 104 must gaze at each desired letter in order for that letter to be selected as an input.

For example, as shown in FIG. 2, a user may gaze at the letters, in sequence, A followed by R, and then followed by the letter T. According to typical eye-typing methods, this input may take on the order of 1.5 to 2 seconds, or more, to enter. However, according to some embodiments described herein, a dwell time can be variable, and in some instances, can be cascading for subsequent letter inputs. This is made possible, in part, by utilizing a lexicographical prediction model, or a probabilistic language model, that determines probabilities for subsequential letter selection.

In some embodiments, a probability is determined for each possible input key after each preceding input has been entered. That is, after each key input is entered, a probability is determined for each key that could possibly be selected as the next key. Based upon the determined probabilities, a dwell time is assigned for each possible key, such that those keys having a higher probability of being selected have a shorter dwell time assigned while, conversely, those keys that have a lower probability of being selected have a longer dwell time. In many embodiments, there is an assigned maximum dwell time assigned to keys that have a relatively low probability of being selected.

The systems described herein may be implemented on a computing device 108 which may include one or more processors 110 and may further have computer-readable media 112 that stores one or more modules or instructions. The one or more processors 112 are part of a logic subsystem of the computing device 108 while the computer-readable media 112 forms a part of the storage subsystem. The computer-readable media 112 is non-transitory and may store various instructions, routines, operations, and modules that, when executed, cause the processors to perform various activities. In some implementations, the one or more processors are central processor units (CPU), graphics processing units (GPU) or both CPU and GPU, or any other sort of processing unit. The non-transitory computer-readable storage media may include volatile and nonvolatile, removable and non-removable tangible, physical media implemented in technology for storage of information, such as computer readable instructions, data structures, program modules, or other data. System memory, removable storage, and non-removable storage are all examples of non-transitory computer-readable media. Non-transitory computer-readable storage media may include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the system.

A probabilistic language model 114, also referred to as a language model or a lexicographical model may utilize a dictionary 118 of known words in order to predict a word or a string of words that a user is entering. The language model may incorporate a word prediction engine 116 that compares a string of entered text against the words in the dictionary 118 to predict a word or string of words that a user is in the process of entering and the language model 114 can then use this prediction information to determine probabilities for the subsequential key.

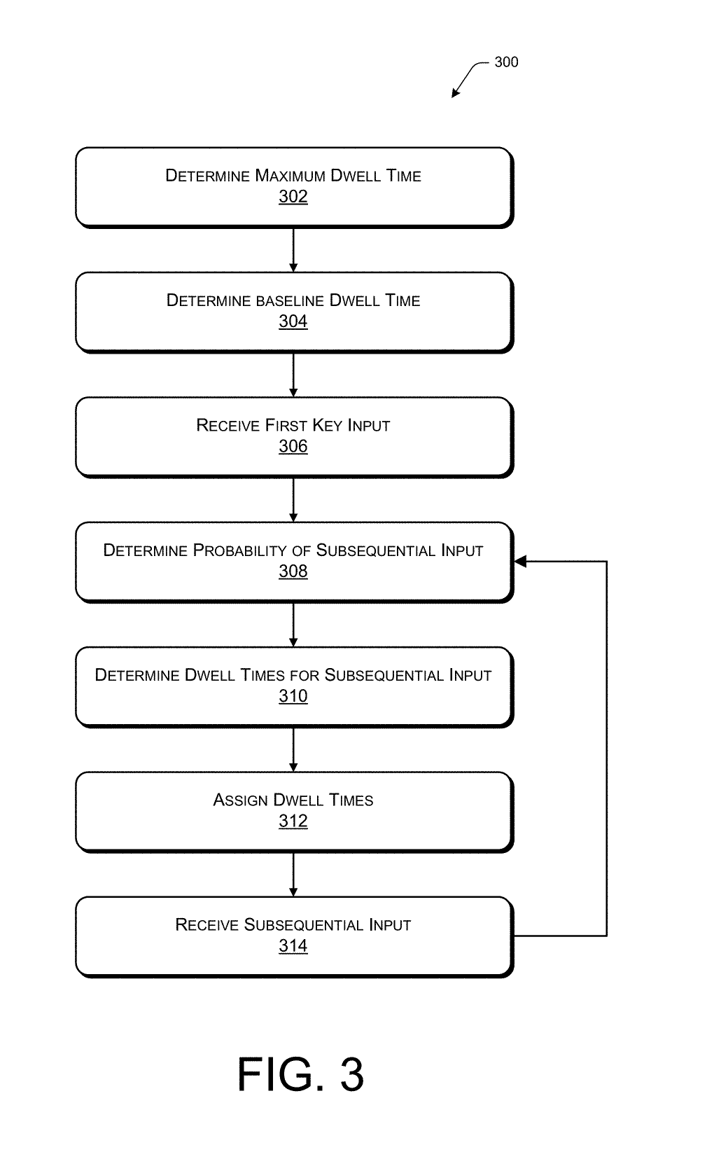

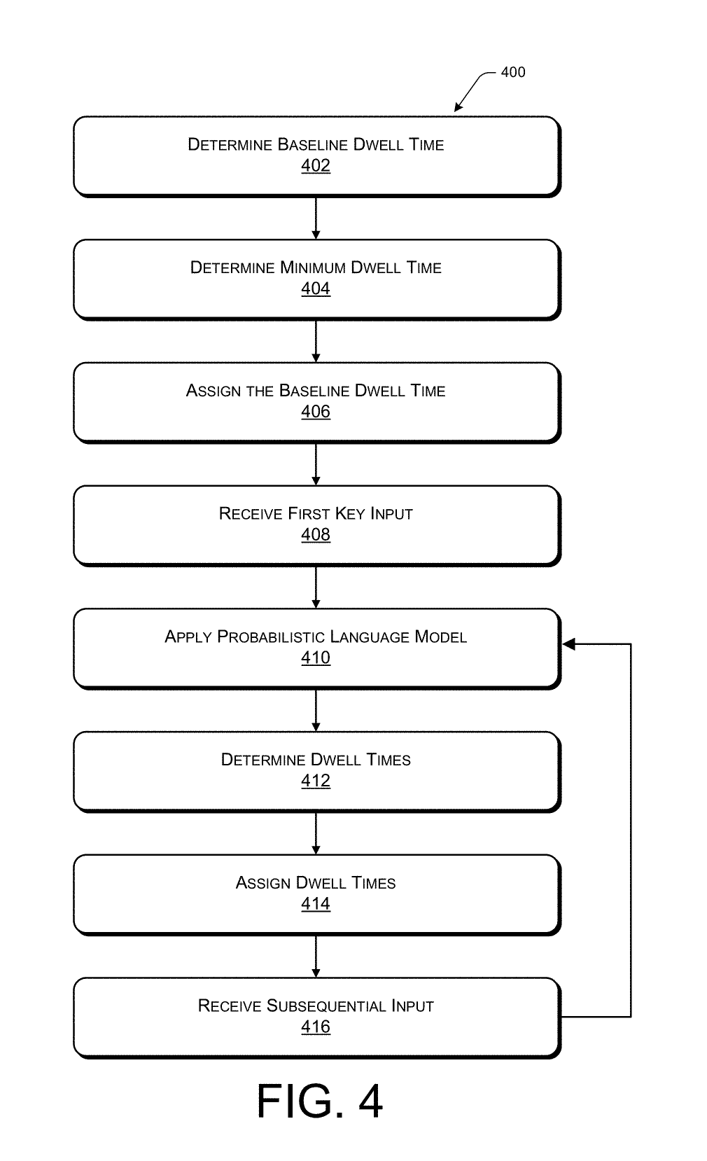

FIGS. 3 and 4 are flow diagrams showing several illustrative routines for determining and assigning dwell times in a gaze-based typing system, according to embodiments disclosed herein. It should be appreciated that the logical operations described herein with respect to FIGS. 3 and 4 are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, or any combination thereof. It should also be appreciated that more or fewer operations may be performed than shown in the figures and described herein. These operations may also be performed in parallel, or in a different order than those described herein.

The method 300 may be carried out by a local client device that includes a display 102 configured to present an on-screen keyboard 200, by a remote computing device configured to communicate with a local computing device that includes a display for presenting an on-screen keyboard, or in some other suitable manner. That is, the method 300 may be performed by a local computing device or on a remote computing device in communication with the display and eye-tracking sensors, or by a combination of local and remote computing resources.

As shown in FIG. 3, a flow diagram is provided to illustrate a possible process 300 for determining dwell times by applying a language model 114. At block 302, a maximum dwell time is determined. This may be specified by user preference based upon the experience and skill level with respect to gaze-based typing of the user. In some instances, the maximum dwell time may be programmed into the system 100 and is not configurable. In still other implementations, the maximum dwell time may be variable based upon the probabilistic language model 114. In some instances, the maximum dwell time may be established prior to the beginning of text entry and then gradually increased or decreased as the user types. The maximum dwell time may be on the order of 600 ms, 800 ms, 1000 ms, 1200 ms or more and may depend on the specific gaze-based typing implementation and the preferences or experience of the user of the system.

At block 304, a baseline dwell time is determined and, similar to the maximum dwell time, may be based upon the preferences or experience of the user of the system 100. In many embodiments, the baseline dwell time is lower than the maximum dwell time, but in some instances, may be equal to the maximum dwell time. For example, when receiving an initial input, the baseline dwell time and the maximum dwell time may be the same since there are no previous entries upon which to determine subsequent probabilities.

At block 306, a first key input is received. The first key input is generally received by the gaze-tracking sensor(s) 106 that track the gaze of the user 104. As the gaze of the user 104 dwells upon a character presented in association with the first key of the display 102 as part of the on-screen keyboard 200 for the duration of the baseline dwell time, the gaze-tracking sensors 106 detect the desired entry and the corresponding character presented in association with the first key is entered as text. Once the first character is entered, the language model 114 is used, and at block 308, the probability of the subsequential input is determined. The language model 114 may be letter based, word based, or phrase based. That is, the language model may determine the probability of a subsequent letter, or of a subsequent word or phrase, based upon the previously entered text. For explanation purposes, the primary examples used herein will describe a letter-by-letter probability determination.

Any suitable statistical language model may be implemented along with the techniques described herein. For example, an n-gram model may be used. An n-gram model is a type of probabilistic language model and comprises a continuous sequence of n items from a given sequence of text. The items can be letters, words, phenomes, syllables, or base pairs. When used with the methods and techniques described herein, the n-gram models may be unigrams (where n=1), bigrams (n=2), trigrams (n=3) or some other desired variant. Of course, other probabilistic language models may be used, such as Bayesian inference, continuous space models, or some other model that is able to determine the probability of the subsequential input.

As an example, once an initial letter is received, the probability of the subsequential input is determined for each available input key. That is, with a keyboard having 26 characters, the probability of each of the 26 characters is determined. At block 310, the dwell time for each character may be adjusted up or down based upon the probability of that character being the subsequential input. For example, as described above, if the first three inputs are selection of the keys corresponding to the characters A, R, and T, the probability that each key on the keyboard will be the subsequential input will be determined. Keys corresponding with the character I or the space bar, for example, may have a relatively high probability, while keys corresponding with the characters Z or Q, may have a relatively low probability of being the subsequential input. At block 312, based upon the determined probabilities, each key may be assigned a dwell time. Correspondingly then, the key corresponding with the character I or the space bar may be assigned a dwell time shorter than the baseline dwell time, while the keys corresponding with the characters Z and Q may be assigned a dwell time higher than the baseline dwell time. In fact, the characters Z and Q may have a very small probability of being the subsequential input, such as less than 0.1%, and therefore, their keys may be assigned to have the maximum dwell time.

Continuing, the key corresponding with the character I or the space bar may be assigned to have a dwell time that is lower than the baseline dwell time. Assuming that the I-key and the space bar both have the highest probability of being the subsequential input based upon the language model, these two keys may be assigned to have the minimum dwell time, which may be gradually reduced as confidence in the subsequential character increases.

At block 314, the subsequential input selecting a next key is received by detecting the gaze of the user falling upon a key of the on-screen keyboard for the assigned dwell time and the process repeats from block 308 by determining the probability of the subsequential input. It should be apparent that, in many cases, as additional characters are entered, the probability of the subsequential input increases in certainty. For example, where the first three inputs are the characters A, R, and T, the probability of the subsequential input being the character I or the space bar are relatively high. However, once the next inputs are detected as the character I followed by the character S, so the total input comprises, in order, A, R, T, I, and S, the probability of the next character becomes more certain based upon the language model 114. In other words, given a list of words within the dictionary 118, there may be only a small number of words that begin with the entered characters, and thus, many characters on the keyboard are not very likely to be the subsequential input. The process repeats by returning to block 308, and continuing to apply the language model 114 and determining the probability of each key being selected as the subsequential input. As additional characters are input, the language model 114 is able to narrow down the list of probable words that are being entered and thereby is able to narrow down the list of available characters, thereby increasing the probability of subsequential characters that fit the language model.

As additional letters of a word are entered, the system may gradually reduce the minimum dwell time, or in other words, may be considered as implementing a cascading minimum dwell time. That is, the minimum dwell time may gradually reduce as additional letters of a word are entered. Of course, the minimum dwell time may only be applied to those keys that have a very high probability of being the subsequential input, and the remaining keys will have a dwell time that is higher than the minimum dwell time.

In some embodiments, maintaining a typing rhythm or cadence provides a user with a comfortable rate of text input and reduces typing errors. Hence, in some embodiments, the minimum cascading dwell time gradually decreases, such as by about 10%, 15%, 20%, or some other desired increment below the previous cascading minimum dwell time down to an absolute minimum dwell time, which may be established by the system or by a user. In some embodiments, the absolute minimum dwell time may be on the order of 100 ms. Of course, the absolute minimum dwell time could be set to zero where the probability of the subsequential input is near 100%; however, some embodiments limit the absolute minimum dwell time to a non-zero value to maintain a comfortable typing cadence.

Once an entire word is entered, such as by selecting the space bar, the system may reset the cascading minimum dwell time to equal the baseline dwell time and the system repeats the steps for the next word. In some embodiments, the language model is used to determine a probability of the next word and the baseline dwell time or the cascading minimum dwell time may be determined, at least in part, on the probability of the next word and the corresponding characters.

FIG. 4 illustrates another flow diagram representing another possible process 400 for determining dwell times by applying a language model 114. At the outset, at block 402, a baseline dwell time is established. As described above, the baseline dwell time may be influenced by the language model 114 and the probability that the subsequential input will comprise a word having a relatively high probability of being entered next in time. In other instances, the baseline dwell time is static and the dwell times for subsequential inputs are determined relative to the baseline dwell time.

At block 404, the minimum dwell time is established, which in some cases, is an absolute minimum. As described above, it may be zero or may be set to a non-zero time duration, such as, for example, 100 ms, 200 ms, 300 ms, or some other variation.

At block 406, every possible input key may be assigned the baseline dwell time. Without having any previously input text to reference, the probability of each key may be close to equal. However, in those instances where there is a corpus of text to analyze, the baseline dwell time may be assigned individually for each key based upon the probability that the next word to be input has a relatively high probability. A corpus of text may be determined by the language model 114 and one or more dictionaries 118 utilized by the system 100 in the probability determination. The dictionaries 118 may be internal to the system 100, or may be stored externally to the system 100, or may be a combination. For example, the system 100 may retrieve an external dictionary 118 for general use, and may further maintain a local dictionary 118 that is personalized to the user.

Additionally, the dictionary 118 may be customized based upon the content of the text that the user is typing. For example, where a user enters abbreviations, formulas, or technical terms that may not readily be available in standard dictionaries, the dictionary 118 may be amended by adding to it the terms, abbreviations, or formulas entered by the user. Additionally, a user dictionary 118 may be created, either locally or remotely, that can be used by the system 100 in its word probability determination in conjunction with, or in lieu of, other dictionaries 118 that may be referenced by the system 100. Finally, content specific dictionaries 118 may also be used. For example, if a user types the names of particular artists or references works of art, the system 100 may determine that the user is entering text related to artists and their works, and may choose an appropriate dictionary that may include content-specific words that may not be found in other standard dictionaries.

At block 408, a first key input is received based upon the initial dwell time assigned to each key and the gaze of the user being detected as a desired input. In some embodiments, the initial dwell time is the baseline dwell time and all keys are assigned the baseline dwell time. However, in some cases, each key is assigned a dwell time based upon the language model 114 and may be different from the baseline dwell time.

At block 410, the probabilistic language model 114 is applied, which may be applied on a letter-by-letter basis, may be phrase-based, or may be word-based, or may be a combination. At block 412, dwell times are determined for each key on the on-screen keyboard 200. According to some embodiments, the dwell times are assigned based upon the probability that an individual character will be the subsequential key. For example, where the first character of a word is the letter Q, there is a high probability that the subsequential input will be the letter U. Accordingly, the letter U will be assigned the cascading minimum dwell time. However, the probability that the letter U will come next is not 100% since other characters are entirely possible and there are numerous words that do not follow the convention of the letter U immediately following the letter Q. For example, the English word “qiana,” which is a type of nylon material, does not follow the convention and the letter I may be assigned a dwell time that is lower than the baseline dwell time but higher than the cascading minimum dwell time. Similarly, many other anglicized words from other languages do not follow the U after Q convention. Consequently, while the probability of the letter U following the letter Q is quite high, it is not absolute. Similarly, where a dictionary does not recognize any words in which the letter Z follows the letter Q, once the letter Q is input, the letter Z may be assigned the maximum dwell time since it is highly unlikely that the letter Z will be the subsequential input.

Where the confidence level of the subsequential input has a very high probability, such as the letter U following the letter Q, the system may not immediately reduce the dwell time of the letter U to the minimum dwell time; but rather, may use a cascading minimum dwell time. That is, the reduction in dwell time for the subsequential input is only gradually reduced to help maintain a comfortable typing cadence. Of course, the dwell time could be reduced to zero or near zero where the subsequential key probability is high; however, that may interrupt the rhythm and cadence for the user. Consequently, in some embodiments, a cascading minimum dwell time is implemented, where the dwell time for a highly probable subsequential input is gradually reduced, such as by about 5%, 10%, 15%, 20%, 30%, or some other increment, as subsequent characters are input. The result is that as subsequent characters in a word or phrase have a relatively high probability of being entered next, the cascading minimum dwell time will gradually decrease until the subsequential input is assigned the minimum dwell time. However, a gradual reduction in the cascading minimum dwell time is not mandatory between subsequent characters, as the dwell time may remain the same, or may even slightly increase for some characters as the language model determines that an increased number of characters are possible or probable.

The result is that the dwell times of keys entered after the initial key are dynamically determined based on the likelihood that the key is to be selected next. According to some embodiments, the language model 114 utilizes the character input stream to generate an N-Best list of predicted words. That is, based upon the previous input(s), a list is generated comprising the likely words that a user is entering. The system 100 may iterate through each word in the N-Best list and count the occurrence of characters that appear next in the word from the current input character. The likelihood of each key may be determined by dividing the number of occurrences of the character that the key represents by the total number of words in the N-Best list. The summation of all key likelihoods is typically equal to 1.

Keys with a probability of being the subsequential input of less than a predefined low probability threshold (e.g., about 0.01 (1%), 0.02 (2%), 0.03 (3%), etc.) have their dwell time set to a predetermined maximum dwell time. In some embodiments, the maximum dwell time is about 1000 ms, or 800 ms, or some other desired increment, and may be established by user preference. For keys having a probability of greater than the predefined low probability threshold (e.g., 0.01), there may be two scores assigned to that key. The first score is based on the number of adjacent keys surrounding the key which are also likely to be selected as the subsequential input. The equation for score one (S₁) may be approximated as:

$${S}_{1} = ( ( \frac{{a}_{l}}{{a}_{t}} ) * ( {dt}_{bl} - {dt}_{c - min} ) ) + {dt}_{c - min}$$

where aₗ is the number of likely adjacent keys, aₜ is the total number of adjacent keys, dt_{bl} is the baseline dwell time, and dt_{c-min} is the cascading minimum dwell time. The number aₗ may be determined based upon the number of adjacent keys that have a probability of being the subsequential input that is greater than a threshold value, such as 5%, or 10%, or more. If aₗ has a value of 0, indicating that no adjacent keys are likely to be selected, Sₗ need not be calculated, since the dwell time of the key is set to the current cascading minimum dwell time (cmdt). If aₗ does not equal 0, the second score is calculated.

The second score is based on the probability that the key is to be selected as the subsequential input. The equation for score two (S₂) may be approximated as:

S₂=((1−kₖ)*(dt_{bl}−dt_{c-min}))+dt_{c-min}

where kₗ is the probability of a given key (a value between 0.01 and 1.0), dt_{bl} is the baseline dwell time, and dt_{c-min} is the cmdt. Thus, as kₗ approaches 1, S₂ approaches the cmdt.

Once these two scores are calculated (assuming both are required), the maximum value of either S₁ or S₂ is chosen and the dwell time for the key is set to the score value. Accordingly, where a key has a probability that is above the low probability threshold (e.g. 0.01), the dwell time for that key will be less than or equal to the baseline dwell time. Correspondingly, where a key has a probability that is below the low probability threshold (e.g. 0.01), the dwell time for that key will range, inclusively, from the baseline dwell time to the maximum dwell time. As described herein, these two calculations may be performed for each key on the virtual keyboard after each input is received. The result is a dynamically variable dwell time for each key with a cascading minimum dwell time that is gradually reduced as confidence in the subsequential input increases.

There may be instances where the language model 114 is unable to return any word results, thereby resulting in no key that has a probability greater than any other key. In such cases, the system determines that either (1) the user has made a spelling error which results in an unrecognizable word, or (2) that the user is typing a word not found in the utilized dictionary, such as an email address, abbreviation, technical term, or other non-dictionary based word. In such cases, the dwell time for the subsequential key may be set to the maximum dwell time, or some other desirable dwell time, such as, for example 160% of the baseline dwell time. This increased dwell time allows a user to continue to enter text at a reasonable rate, while also signaling that there may possibly be a spelling error.

The dynamic dwell times are also applicable to non-character keys, such as the Space key or the Backspace key. For example, as a user enters text, the system may perform a dictionary lookup of the entered text after each key selection. If the entered text matches a word in the dictionary, the dwell time of the Space key may be reduced, such as according to the cascading minimum dwell time, or reduced by a fixed amount, or reduced to a fixed dwell time. In some instances, the dwell time of the Space key may be reduced by 33% of the baseline dwell time. In other instances, the dwell time of the Space key may be reduced to the minimum dwell time. If, during the course of text entry, the entered text does not match a word in the dictionary, the dwell time of the Space key may be set to equal the baseline dwell time, or the maximum dwell time, or some value in between.

Similarly, the dwell time of the Backspace key may also be set based upon the word prediction results. For example, where the system returns no predicted word results, the dwell time of the Backspace key may be set to the minimum dwell time. This reduced key dwell time allows a user to quickly correct errors. Once the Space key has been selected, indicating the completion of a word, the dwell times of the Space key and the Backspace key may be reset to the baseline dwell time.

At block 416, the subsequential input is received and entered. At this point, the system 100 returns to block 410 and applies the language model 114 to predict the subsequential input and determine and assign dwell times for each key on the on-screen keyboard 200.

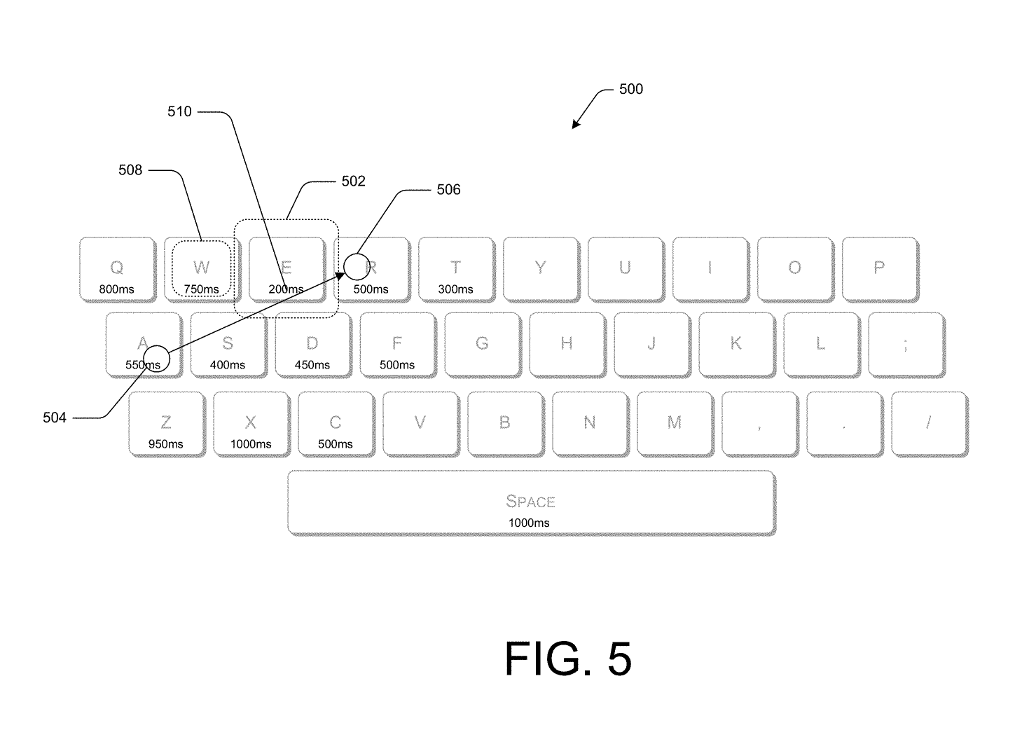

FIG. 5 illustrates a gaze-based keyboard 500 in which the target 502 of a key is increased in size based upon the probability that the key will be the subsequential key. In some instances, the target 502 that a user must gaze at for the dwell time in order to select the key may be sized to be equal to the boundary of the key as displayed on the on-screen keyboard 500. However, in some instances, such as where the probability of a key being the subsequential key is quite high, the target 502 for that key may be increased in size. This, in effect, not only makes it easier to select the key, but also reduces the time the user must gaze at the key because the system begins counting the dwell time before the gaze of the user reaches the intended key.

Similarly, in some instances, where a key is determined to have a low probability of being the subsequential key, the target 508 for that key may be reduced in size, thereby effectively making it more difficult to select that key. While it is still possible to select the key, it is made more difficult not only because the target has decreased in size, but also because the system only begins counting the dwell time once the user's gaze falls within the reduced size target.

As an example, where the first input is the letter A 504 followed by the letter R 506, there are many possible entries that could be the subsequential input. However, based upon the language model 114 and the corpus of text used in conjunction with the dictionary 116, the system may determine that the most likely subsequential input is the letter E followed by the Space bar. Thus, after entering the keys A and R, the character E is assigned a dwell time (e.g., 200 ms as shown in FIG. 5) that may be shorter than the baseline dwell time and the target 502 for the key corresponding with the character E may be increased in size beyond the boundary of the key displayed on the keyboard, thus making it easier for a user to enter that character. Other keys, such as the character W may have a very low probability of being the subsequential key; therefore, the character W may have a longer dwell time (e.g., 750 ms as shown in FIG. 5) and its target 508 may be reduced in size thereby making it more difficult to enter that character.

As further shown in FIG. 5, where the character E is determined to have the highest probability of being the subsequential input, a minimum dwell time 510 may be assigned, such as here, 200 ms. Dwell times may be assigned to each key on the on-screen keyboard based upon the probability of that key being the subsequential input. As illustrated, the character E has the highest probability of being the subsequential input, and therefore, has the shortest dwell time assigned, and in some embodiments, may also have its target 502 increased in size. Other keys are entirely possible as there are numerous dictionary-based words that begin with the letters A and R; therefore, as illustrated, there may be unique dwell times assigned to each key based upon the probability of that key being selected as the subsequential input. Where a dictionary may not have any words that contain the letters, in order, A,R, and X, the letter X may be assigned the maximum dwell time, such as 1000 ms.

While FIG. 5 illustrates that the assigned dwell times are based upon 50 ms increments, the systems and methods should not be limited in this way. Of course, dwell times may be truly variable and have any increment desirable.

The probability may be determined by the language model 114 and may be based upon the fact that the letters A,R,E appear in combination at a much higher frequency that the letters A,R,T, for example. However, the probability of the subsequential input can be influenced by the corpus of text being entered by the user. For example, where the previous input by the user spells “It is a beautiful spring day, the birds ar_,” the language model 114 may predict with a high degree of confidence that the subsequential input is the letter E, and thus, may assign that character to have the minimum dwell time. As another example, where the user has previously entered the text “Michelangelo is my favorite Renaissance ar_,” the language model 114 may confidently predict that the subsequential input may be the letter T, followed further by the letters I,S,T. The dwell time module 120 can determine and assign the dwell times for these characters based upon the high probability that the user is in the process of entering the word ARTIST and gradually reduce the dwell time for subsequent characters.

### Example Clauses

According to some embodiments, a computing device comprises a display, a storage subsystem, and a logic subsystem. The storage subsystem stores instructions that when executed by the logic subsystem cause the computing device to perform operations comprising (1) presenting, on the display, a keyboard comprising at least a first key and a second key; (2) assigning a baseline dwell time to the first key, the baseline dwell time determining how long a user must gaze at the first key in order to select the first key; (3) detecting, through a gaze-tracking sensor, selection of the first key; (4) determining, based upon a language model, a probability that the second key will be a next key selected; and (5) determining, based upon the probability, a dwell time for the second key, wherein the dwell time is shorter than the baseline dwell time.

In addition, the keyboard may further comprise a third key and the operations may further comprise determining, based upon the language model, a second probability that the third key will be the next key selected after the second key; and determining, based upon the second probability, a second dwell time for the third key. The second dwell time for the third key may be shorter than the dwell time for the second key.

In some instances, the operations further comprise determining a maximum dwell time; and assigning the maximum dwell time to the third key based upon the probability that the third key will be the next key selected after the second key is lower than a predefined minimum probability. Moreover, the operations further comprise determining, based upon the language model, that a complete word has been entered and assigning a minimum dwell time to a space key of the keyboard.

According to another embodiment, a method for eye-typing, comprises determining a baseline dwell time for one or more keys displayed in an on-screen keyboard; receiving a first input corresponding with a first key; determining a probability that a second key will be a next key selected via a second input immediately following reception of the first input; determining, based at least in part on the probability, a second dwell time for the second key; and assigning the second dwell time to the second key. The method may further comprise receiving the second input corresponding with the second key; determining a second probability that a third key will be another next key selected via a third input immediately following reception of the second input; and determining, based upon the second probability, a second dwell time for the third key.

In some instances, a most probable key is assigned a minimum dwell time, and the minimum dwell time may comprise a cascading minimum dwell time that decreases from a first most probable key to a second most probable key, the second most probable key being determined after the first most probable key is selected.

In some cases, the most probable key is determined by generating an N-best list of words, based at least in part upon a first character associated with the first key selected via the first input, the method further comprising determining occurrences of characters that appear immediately after the first character in words in the N-best list of words, and dividing a number of the occurrences by a number of words in the N-best list of words.

The second key may be a space key and the second dwell time is shorter than the baseline dwell time based upon a determination that a string of text previously input corresponds with a word contained in a dictionary.

Alternatively, the second key may be a backspace key and the second dwell time is shorter than the baseline dwell time based upon a determination that a string of text previously input does not correspond with a word contained in a word prediction engine.

The probability that the second key will be the next key selected via the second input may be determined based at least in part upon a number of keys that are adjacent to the second key in the on-screen keyboard which are likely to be selected.

According to yet another embodiment, a system for eye-typing, comprises one or more processors having memory communicatively coupled thereto; a display; instructions stored on the memory that, when executed by the one or more processors, cause the system to: present a gaze-based keyboard on the display, the keyboard having one or more keys selectable by gazing at individual ones of the one or more keys for a dwell time; determine a probability that individual ones of the one or more keys will be selected next; and determine, based at least in part on the probability, a dwell time for an individual key.

A second dwell time associated with a second key may be shorter than a first dwell time associated with a first key based at least in part on the second key being associated with a first character that more likely follows, in a word defined within a language model, a selected character compared to a second character associated with the first key. The dwell time may be set to a maximum dwell time for individual keys of the one or more keys where the probability of the individual keys being selected next is less than a predefined threshold.

In some cases, the dwell times associated with a sequence of keys selected is gradually reduced from one key to a next key based upon a number of keys in the sequence of keys that have been previously selected.

An individual key of the one or more keys may have a boundary that defines an area within which the individual key is selectable. The boundary may be sized, based at least in part, upon the probability that the key will be selected next. The boundary may be increased in size based upon the probability that the key will be selected next is greater than a predefined threshold.

### CONCLUSION

Although the present disclosure may use language that is specific to structural features and/or methodological acts, the invention is not limited to the specific features or acts described herein. Rather, the specific features and acts are disclosed as illustrative forms of implementing the invention.

What is claimed is:

1. A computing device comprising a display, a storage subsystem, and a logic subsystem, the storage subsystem storing instructions that when executed by the logic subsystem cause the computing device to perform operations, comprising:
presenting, on the display, a keyboard comprising at least a first key and a second key;
assigning a baseline dwell time to the first key, the baseline dwell time determining how long a user must gaze at the first key in order to select the first key;
detecting, through a gaze-tracking sensor, selection of the first key;
determining, based upon a language model, a probability that the second key will be a next key selected; and
determining, based upon the probability, a dwell time for the second key, wherein the dwell time is shorter than the baseline dwell time.

2. The computing device of claim 1, wherein the keyboard further comprises a third key and the operations further comprise:
determining, based upon the language model, a second probability that the third key will be the next key selected after the second key; and
determining, based upon the second probability, a second dwell time for the third key.

3. The computing device of claim 2, wherein the second dwell time for the third key is shorter than the dwell time for the second key.

4. The computing device of claim 2, wherein the operations further comprise:
determining a maximum dwell time; and
assigning the maximum dwell time to the third key based upon the probability that the third key will be the next key selected after the second key is lower than a predefined minimum probability.

5. The computing device of claim 1, wherein the operations further comprise:
determining, based upon the language model, that a complete word has been entered; and
assigning a minimum dwell time to a space key of the keyboard.

6. A method for eye-typing, comprising:
determining a baseline dwell time for one or more keys displayed in an on-screen keyboard;
receiving a first input corresponding with a first key;
determining a probability that a second key will be a next key selected via a second input immediately following reception of the first input;
determining, based at least in part on the probability, a second dwell time for the second key; and
assigning the second dwell time to the second key.

7. The method as in claim 6, further comprising:
receiving the second input corresponding with the second key;
determining a second probability that a third key will be another next key selected via a third input immediately following reception of the second input; and
determining, based upon the second probability, a second dwell time for the third key.

8. The method as in claim 6, wherein a most probable key is assigned a minimum dwell time.

9. The method as in claim 8, wherein the minimum dwell time comprises a cascading minimum dwell time that decreases from a first most probable key to a second most probable key, the second most probable key being determined after the first most probable key is selected.

10. The method as in claim 8, wherein the most probable key is determined by generating an N-best list of words, based at least in part upon a first character associated with the first key selected via the first input, the method further comprising determining occurrences of characters that appear immediately after the first character in words in the N-best list of words, and dividing a number of the occurrences by a number of words in the N-best list of words.

11. The method as in claim 6, wherein the second key is a space key and the second dwell time is shorter than the baseline dwell time based upon a determination that a string of text previously input corresponds with a word contained in a dictionary.

12. The method as in claim 6, wherein the second key is a backspace key and the second dwell time is shorter than the baseline dwell time based upon a determination that a string of text previously input does not correspond with a word contained in a word prediction engine.

13. The method as in claim 6, wherein the probability that the second key will be the next key selected via the second input is determined based at least in part upon a number of keys that are adjacent to the second key in the on-screen keyboard which are likely to be selected.

14. A system for eye-typing, comprising:
one or more processors having memory communicatively coupled thereto;
a display;
instructions stored on the memory that, when executed by the one or more processors, cause the system to:
present a gaze-based keyboard on the display, the keyboard having one or more keys selectable by gazing at individual ones of the one or more keys for a dwell time;
determine a probability that individual ones of the one or more keys will be selected next; and
determine, based at least in part on the probability, a dwell time for an individual key.

15. The system as in claim 14, wherein a second dwell time associated with a second key is shorter than a first dwell time associated with a first key based at least in part on the second key being associated with a first character that more likely follows, in a word defined within a language model, a selected character compared to a second character associated with the first key.

16. The system as in claim 14, wherein the dwell time is set to a maximum dwell time for individual keys of the one or more keys where the probability of the individual keys being selected next is less than a predefined threshold.

17. The system as in claim 15, wherein the dwell times associated with a sequence of keys selected is gradually reduced from one key to a next key based upon a number of keys in the sequence of keys that have been previously selected.

18. The system as in claim 14, wherein the individual key of the one or more keys has a boundary that defines an area within which the individual key is selectable.

19. The system as in claim 18, wherein the boundary is sized, based at least in part, upon the probability that the key will be selected next.

20. The system as in claim 19, wherein the boundary is increased in size based upon the probability that the key will be selected next is greater than a predefined threshold.
